(19) United States
(12) Patent Application Publication
(10) Pub. No.: US 2024/0021000 A1
(43) Pub. Date: Jan. 18, 2024

(54) IMAGE-BASED INFORMATION EXTRACTION MODEL, METHOD, AND APPARATUS, DEVICE, AND STORAGE MEDIUM

(71) Applicant: BEIJING BAIDU NETCOM SCIENCE TECHNOLOGY CO., LTD., Beijing (CN)

(72) Inventors: Xiameng QIN, Beijing (CN); Yulin LI, Beijing (CN); Xiaoqiang ZHANG, Beijing (CN); Ju HUANG, Beijing (CN); Qunyi XIE, Beijing (CN); Kun YAO, Beijing (CN)

(73) Assignee: BEIJING BAIDU NETCOM SCIENCE TECHNOLOGY CO., LTD., Beijing (CN)

(21) Appl. No.: 18/113,178

(22) Filed: Feb. 23, 2023

(30) Foreign Application Priority Data
Jul. 18, 2022 (CN) 202210838350.X

(51) Int. Cl. G06V 30/19; G06V 30/148

(52) U.S. Cl. CPC G06V 30/1918; G06V 30/15; G06V 30/19127; G06V 30/19147

(57) ABSTRACT

There is provided an image-based information extraction model, method, and apparatus, a device, and a storage medium, which relates to the field of artificial intelligence (AI) technologies, specifically to fields of deep learning, image processing, computer vision technologies, and is applicable to optical character recognition (OCR) and other scenarios. A specific implementation solution involves: acquiring a to-be-extracted first image and a category of to-be-extracted information; and inputting the first image and the category into a pre-trained information extraction model to perform information extraction on the first image to obtain text information corresponding to the category.

### CROSS-REFERENCE TO RELATED APPLICATIONS

The present application claims the priority of Chinese Patent Application No. 202210838350.X, filed on Jul. 18, 2022, with the title of “IMAGE-BASED INFORMATION EXTRACTION MODEL, METHOD, AND APPARATUS, DEVICE, AND STORAGE MEDIUM.” The disclosure of the above application is incorporated herein by reference in its entirety.

### FIELD OF THE DISCLOSURE

The present disclosure relates to the field of artificial intelligence (AI) technologies, specifically to fields of deep learning, image processing, computer vision technologies, and is applicable to optical character recognition (OCR) and other scenarios. The present disclosure relates, in particular, to an image-based information extraction model, method, and apparatus, a device, and a storage medium.

### BACKGROUND OF THE DISCLOSURE

In order to accelerate efficiency of information circulation and transmission, structured text has become a mainstream information carrier in daily production instead of natural language, and is widely used in digital and automated office processes.

Despite increasingly significant achievements of global information digitization, there are still a large number of physical documents in daily life required to be recorded, reviewed, and digitized. For example, in a financial department, a large number of entity bills are manually entered many times every day for reimbursement. There are also many personal businesses in banks that require registration of ID cards to bind identity information. People can recognize and digitize physical text by means of an OCR technology. Such unstructured text is further processed into storable structured text, which realizes extraction of structured information of text, supports the intelligentization of corporate offices, and promotes the process of information digitization.

### SUMMARY OF THE DISCLOSURE

The present disclosure provides an image-based information extraction model, method, and apparatus, a device, and a storage medium.

According to an aspect of the present disclosure, a method for image-based information extraction is provided, including acquiring a to-be-extracted first image and a category of to-be-extracted information; and inputting the first image and the category into a pre-trained information extraction model to perform information extraction on the first image to obtain text information corresponding to the category.

According to another aspect of the present disclosure, a method for training image-based information extraction model is provided, including acquiring a training image sample, the training image sample including a training image, a training category of to-be-extracted information, and label region information of information corresponding to the training category in the training image; and training an information extraction model based on the training image sample.

According to yet another aspect of the present disclosure, there is provided an electronic device, including at least one processor; and a memory communicatively connected with the at least one processor; wherein the memory stores instructions executable by the at least one processor, and the instructions are executed by the at least one processor to enable the at least one processor to perform a method for image-based information extraction, wherein the method includes acquiring a to-be-extracted first image and a category of to-be-extracted information; and inputting the first image and the category into a pre-trained information extraction model to perform information extraction on the first image to obtain text information corresponding to the category.

According to a further aspect of the present disclosure, there is provided a non-transitory computer readable storage medium with computer instructions stored thereon, wherein the computer instructions are used for causing a method for image-based information extraction, wherein the method includes acquiring a to-be-extracted first image and a category of to-be-extracted information; and inputting the first image and the category into a pre-trained information extraction model to perform information extraction on the first image to obtain text information corresponding to the category.

It should be understood that the content described in this part is neither intended to identify key or significant features of the embodiments of the present disclosure, nor intended to limit the scope of the present disclosure. Other features of the present disclosure will be made easier to understand through the following description.

### BRIEF DESCRIPTION OF DRAWINGS

The accompanying drawings are intended to provide a better understanding of the solutions and do not constitute a limitation on the present disclosure. In the drawings,

FIG. 1 is a schematic diagram according to a first embodiment of the present disclosure;

FIG. 2 is a schematic diagram according to a second embodiment of the present disclosure;

FIG. 3 is an architectural diagram of an information extraction model according to an embodiment of the present disclosure;

FIG. 4 is a schematic diagram according to a third embodiment of the present disclosure;

FIG. 5 is a schematic diagram according to a fourth embodiment of the present disclosure;

FIG. 6 is a schematic diagram according to a fifth embodiment of the present disclosure;

FIG. 7 is a schematic diagram according to a sixth embodiment of the present disclosure;

FIG. 8 is a schematic diagram according to a seventh embodiment of the present disclosure; and

FIG. 9 is a block diagram of an electronic device configured to implement a method according to an embodiment of the present disclosure.

### DETAILED DESCRIPTION OF PREFERRED EMBODIMENTS

Exemplary embodiments of the present disclosure are illustrated below with reference to the accompanying drawings, which include various details of the embodiments of the present disclosure to facilitate understanding and should be considered only as exemplary. Therefore, those of ordinary skill in the art should be aware that various changes and modifications can be made to the embodiments described herein without departing from the scope and spirit of the present disclosure. Similarly, for clarity and simplicity, descriptions of well-known functions and structures are omitted in the following description.

Obviously, the embodiments described are some of rather than all of the embodiments of the present disclosure. All other embodiments acquired by those of ordinary skill in the art without creative efforts based on the embodiments of the present disclosure fall within the protection scope of the present disclosure.

It is to be noted that the terminal device involved in the embodiments of the present disclosure may include, but is not limited to, smart devices such as mobile phones, personal digital assistants (PDAs), wireless handheld devices, and tablet computers. The display device may include, but is not limited to, devices with a display function such as personal computers and televisions.

In addition, the term “and/or” herein is merely an association relationship describing associated objects, indicating that three relationships may exist. For example, A and/or B indicates that there are three cases of A alone, A and B together, and B alone. Besides, the character “/” herein generally means that associated objects before and after it are in an “or” relationship.

An existing text structured information extraction technology involves mainly extracting semantic content of cards, certificates, bills, and other images, and transforming the semantic content into structured text to realize extraction of structured information. In a conventional technology, manual entry is mainly used, but the manual entry is prone to errors, time-consuming, and laborious, and has high labor costs. At present, a method based on template matching is mainly used for implementation.

The method based on template matching is generally aimed at documents with simple structures. A to-be-recognized region thereof generally has a fixed geometric layout. Text recognition and extraction are implemented by making a standard template file and extracting corresponding text content at a specified position and by using the OCR technology. However, the method based on template matching is required to maintain a standard template for each document format, and cannot deal with cards, certificates, and bills with non-fixed formats. In short, the existing information extraction method is inefficient.

FIG. 1 is a schematic diagram according to a first embodiment of the present disclosure. As shown in FIG. 1, this embodiment provides a method for image-based information extraction, including the following steps.

In S101, a to-be-extracted first image and a category of to-be-extracted information are acquired.

In S102, the first image and the category are inputted into a pre-trained information extraction model to perform information extraction on the first image to obtain text information corresponding to the category.

The pre-trained information extraction model in this embodiment may also be referred to as an image-based information extraction model and configured to extract information from an image. The information extraction model may be a model having a two-tower structure, including two branches, namely an image branch and a text branch. The image branch is mainly configured to extract image features, while the text branch is mainly configured to transform text features, namely query. In structured issues, the query is actually a key corresponding to a value to be extracted. For example, for “Name: Zhang San”, the key corresponds to “Name”, and the value corresponds to “Zhang San”. The information extraction model in this embodiment of the present disclosure may be defined as giving a series of queries and corresponding images and outputting corresponding values of the queries.

Specifically, the category of the to-be-extracted information is a category of information to be extracted from an image. In use, the to-be-extracted first image and the category of the to-be-extracted information are inputted into the pre-trained information extraction model, and then the information extraction model can realize information extraction on the first image, and then obtain the text information corresponding to the category.

According to the method for image-based information extraction in this embodiment, the to-be-extracted first image and the category of the to-be-extracted information are inputted into the pre-trained information extraction model, and then the information extraction model can perform information extraction on the first image according to the category to obtain the text information corresponding to the category. Compared with the prior art, there is no need to arrange corresponding templates for various cards, certificates, and bills separately. The information extraction method in this embodiment is applicable to extraction of any category of information in any type of image in any format, can effectively improve efficiency of information extraction, and has a very wide range of application.

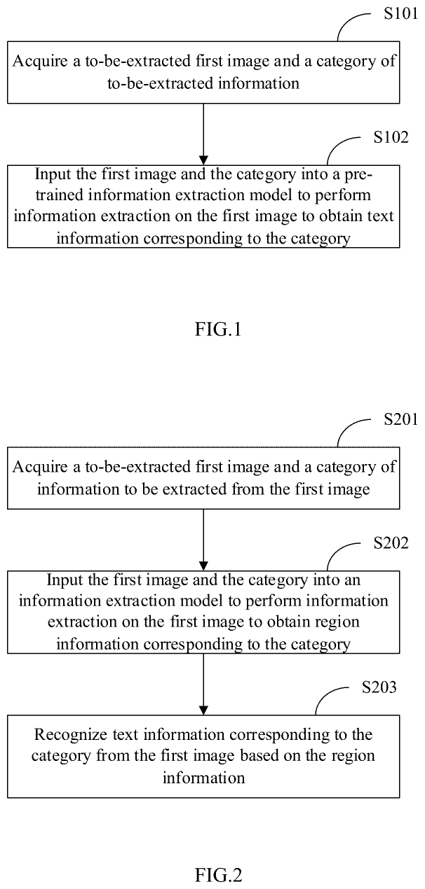

FIG. 2 is a schematic diagram according to a second embodiment of the present disclosure. This embodiment provides a method for image-based information extraction, and introduces the technical solution of the present disclosure in further detail on the basis of the technical solution in the embodiment shown in FIG. 1. As shown in FIG. 2, the method for image-based information extraction in this embodiment may specifically include the following steps.

In S201, a to-be-extracted first image and a category of information to be extracted from the first image are acquired.

The to-be-extracted first image and the category of the information to be extracted from the first image may be inputted into an information extraction apparatus by a user based on a manual interaction module.

In S202, the first image and the category are inputted into an information extraction model to perform information extraction on the first image to obtain region information corresponding to the category.

Specifically, the first image and the category are inputted into the information extraction model, and the information extraction model may extract the region information corresponding to the category from the first image based on the inputted first image and category. For example, the region information herein may be information of a boundary of a region corresponding to the category, such as vertex coordinates of the boundary.

For example, in specific implementation, the method may include the following steps.

(1) The first image is inputted into an image feature extraction module in the information extraction model to perform image feature extraction on the first image to obtain an image feature.

In this embodiment, in specific implementation, the image feature may be extracted by down-sampling at least two layers layer by layer in the image feature extraction module. Resolution corresponding to the image feature is less than that corresponding to the original first image, which can reduce a target and make it easier to acquire the region information corresponding to the category.

The image feature extraction module may be used as a backbone network of the information extraction model to extract the image feature. The backbone network may be implemented based on a convolutional neural network (CNN) or a Transformer-based neural network. For example, in this embodiment, a Transformer-based backbone network may be constructed, and the entire model adopts a hierarchical design. Preferably, in this embodiment, a total of 4 stages may be included. Each stage may reduce the resolution of the inputted image feature, thereby expanding a receptive field layer by layer like the CNN. Compared with a down-sampling role played by Token Merging layers in other stages, a Token Embedding layer of Stage 1 also includes operations of dividing an image into blocks and embedding position information. A Block is specifically formed by Encoders in two Transformers. Compared with an original Encoder formed by a self-attention layer and a feed-forward layer, the first Encoder in the Block replaces the self-attention layer with a window self-attention layer, thereby concentrating calculation of attention on the inside of a fixed-size window, which greatly reduces the amount of calculation. At the same time, the second original Encoder also ensures interactive flow of information between different windows. In this way, an architecture from local to global can significantly improve a feature extraction capability of the model.

(2) The category is inputted into a text feature extraction module in the information extraction model to perform text feature extraction to obtain a text feature.

(3) The image feature and the text feature are inputted into a feature fusion module in the information extraction model and feature fusion is performed based on a cross attention mechanism to obtain a fusion feature.

The feature fusion in this embodiment is intended to fuse the image feature and the text feature, so that a final feature can combine both visual and semantic characteristics. The fusion module may be implemented using a cross attention mechanism in a transformer encoder.

(4) The fusion feature is decoded by using a decoder in the information extraction model, to obtain the region information.

During the decoding, the corresponding image feature and the corresponding text feature may be first acquired respectively from the fusion feature after the fusion. In this case, the image feature has been down-sampled multiple times in an extraction stage. For example, in the above 4 stages, 2 times of down-sampling is also performed prior to entering into the stages, and then 2 times of down-sampling is performed step by step in the 4 stages, which is equivalent to performing 32 times of down-sampling finally. In order to improve accuracy of the region information corresponding to the category acquired, the image feature part in the fusion feature after the fusion can be up-sampled first, but a multiple of the up-sampling may be less than that of the foregoing down-sampling. For example, the image feature after the fusion may be up-sampled 8 times to obtain an image feature that is ¼ the size of the original image, or also referred to as a feature image. Then, a point multiplication operation is performed on the obtained image feature and the text feature part in the fusion feature after the fusion to acquire a further fusion feature that is ¼ the size. Alternatively, in practical applications, 2 times, 4 times, or 16 times of up-sampling may also be performed. Preferably, a finally obtained image feature that is ¼ the size of the original image brings an optimal effect.

The fusion feature that is obtained after point multiplication and ¼ the size can identify the region information corresponding to the category. For example, each pixel in the fusion feature corresponds to a probability value. If the probability value is greater than or equal to a preset threshold, it may be considered that the pixel is a region corresponding to the category. On the contrary, if the probability value of the pixel is less than the preset threshold, it may be considered that the pixel is not the region corresponding to the category. In order to identify the region corresponding to the category more clearly, in the fusion feature, probability values of positions where the probability values are greater than or equal to the preset threshold may all be set to 1, while probability values of positions where the probability values of the pixels are less than the preset threshold are all set to 0. In this way, the region corresponding to the category can be clearly identified and the corresponding region information can be acquired accordingly. If the region corresponding to the category is a rectangle box, the corresponding region information may be four vertices of the rectangle box.

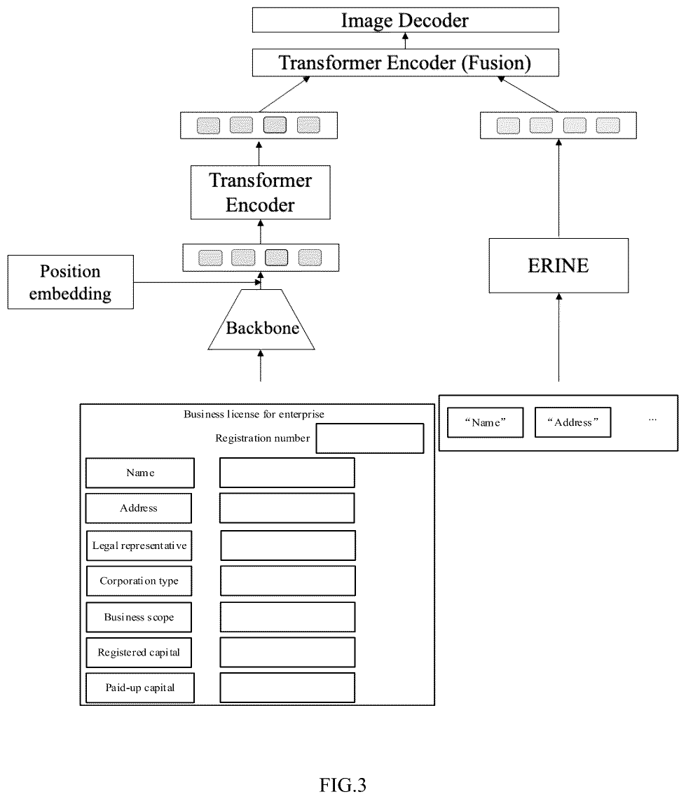

For example, FIG. 3 is an architectural diagram of an information extraction model according to an embodiment of the present disclosure. Based on the architecture, step (1) to step (4) above can be implemented.

In this embodiment, the region information corresponding to the category may also be outputted for users' reference, which can also enrich types and content of information extraction.

In S203, text information corresponding to the category is recognized from the first image based on the region information.

For example, in specific implementation, firstly, the second image corresponding to the information corresponding to the category in the first image may be clipped from the first image based on the region information corresponding to the category. Then, the text information corresponding to the category is acquired based on the second image. Specifically, text in the second image is recognized by OCR, and the text information corresponding to the category can be accurately obtained. In this way, compared with the original image, the target image is smaller, which can narrow a region of recognition of the text information and improve extraction accuracy and extraction precision of the text information corresponding to the category.

It is to be noted that, if there are a plurality of categories to be extracted, region information and text information corresponding to the regions are successively acquired in the manner in the above embodiment.

According to the method for image-based information extraction in this embodiment, the first image and the category of the to-be-extracted information are inputted into the information extraction model, the region information corresponding to the category can be acquired, and then the text information corresponding to the category can be recognized from the first image based on the region information corresponding to the category, which realizes extraction of the region information corresponding to the category and the text information corresponding to the category, can improve accuracy of the extracted text information, and can also effectively enrich content of information extraction. Moreover, the information extraction method in this embodiment is implemented using the information extraction model. The information extraction model includes an image feature extraction module, a text feature extraction module, a feature fusion module, and a decoder. Information processing is very accurate and very intelligent. The information extraction model is applicable to various scenarios for information extraction. For example, information extraction of multi-format and non-fixed-format cards, certificates, and bills may be realized, which expands a scope of services covered by information extraction and has strong scalability and versatility.

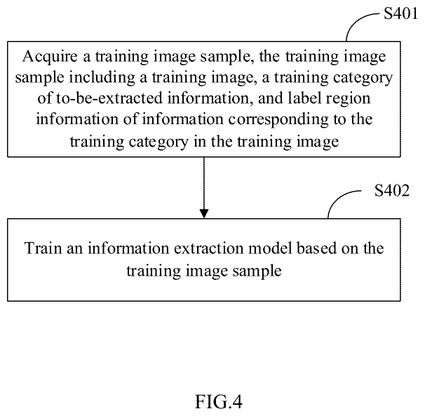

FIG. 4 is a schematic diagram according to a third embodiment of the present disclosure. As shown in FIG. 4, this embodiment provides a method for training image-based information extraction model, including the following steps.

In S401, a training image sample is acquired, the training image sample including a training image, a training category of to-be-extracted information, and label region information of information corresponding to the training category in the training image.

In S402, an information extraction model is trained based on the training image sample.

In this embodiment, a plurality of training image samples may be provided during the training. There may be one, two or more training categories in each training image sample. Correspondingly, for each training category, corresponding label region information is required to be marked. During the training, the information extraction model may be trained based on the training image samples. The information extraction model in this embodiment may also be referred to as an image-based information extraction model, that is, the information extraction model in the embodiments shown in FIG. 1 and FIG. 2, and configured to extract information from an image.

According to the information extraction model training method in this embodiment, in the above manner, the information extraction model is trained by using the training image, the training category of the to-be-extracted information, and the label region information of the information corresponding to the training category in the training image in the training image sample, which can effectively ensure accuracy of the trained information extraction model.

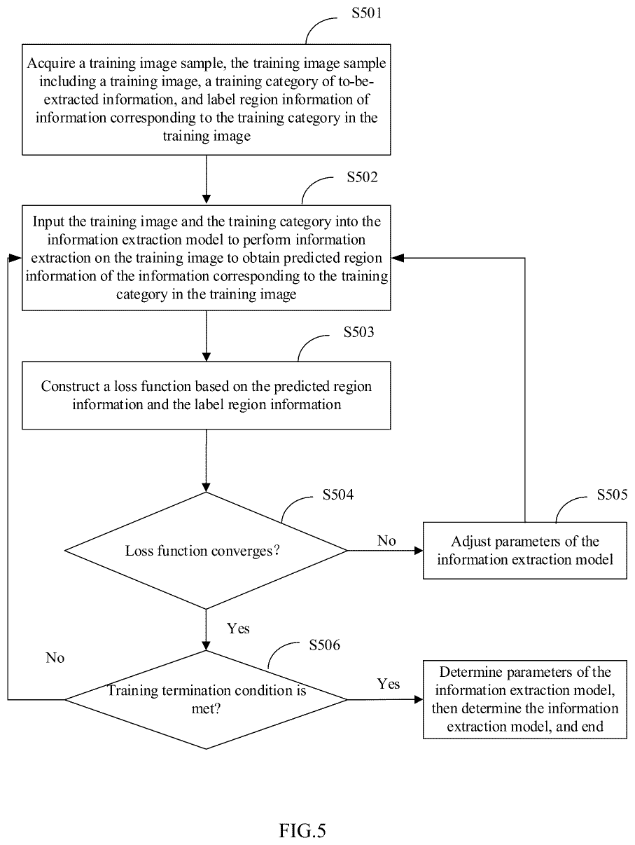

FIG. 5 is a schematic diagram according to a fourth embodiment of the present disclosure. As shown in FIG. 5, this embodiment provides a method for training image-based information extraction model, including the following steps.

In S501, a training image sample is acquired, the training image sample including a training image, a training category of to-be-extracted information, and label region information of information corresponding to the training category in the training image.

In S502, the training image and the training category are inputted into the information extraction model to perform information extraction on the training image to obtain predicted region information of the information corresponding to the training category in the training image.

For example, in specific implementation, the method may include the following steps.
(a) The training image is inputted into an image feature extraction module in the information extraction model to perform image feature extraction on the training image to obtain a training image feature.
(b) The training category is inputted into a text feature extraction module in the information extraction model to perform text feature extraction to obtain a training text feature.
(c) The training image feature and the training text feature are inputted into a feature fusion module in the information extraction model and feature fusion is performed based on a cross attention mechanism to obtain a training fusion feature.
(d) The training fusion feature is decoded by using a decoder in the information extraction model, to obtain the predicted region information.

A specific implementation process may be obtained with reference to steps (1) to (4) in the embodiment shown in FIG. 3. Details are not described herein again.

In S503, a loss function is constructed based on the predicted region information and the label region information.

In S504, it is detected whether the loss function converges, and step S505 is performed if the loss function does not converge; and step S506 is performed if the loss function converges.

In S505, parameters of the information extraction model are adjusted, and step S501 is performed to continue to acquire next training image sample to train the information extraction model.

For example, in this embodiment, the parameters of the information extraction model are adjusted to converge the loss function.

In S506, it is detected whether a training termination condition is met; and if yes, the parameters of the information extraction model are determined, the information extraction model is then determined, and the process ends. If not, step S501 is performed to continue to acquire next training image sample to train the information extraction model.

The training termination condition in this embodiment may be a number of times of training reaching a preset number threshold. Alternatively, it is detected whether the loss function converges all the time in a preset number of successive rounds of training, the training termination condition is met if convergence occurs all the time, and otherwise, the training termination condition is not met.

According to the information extraction model training method in this embodiment, in the above manner, the information extraction model can be trained based on the training image sample by taking label region information of a text box corresponding to the training category in the training image sample in the training image as supervision, which can effectively ensure accuracy of the trained information extraction model, and then can improve accuracy and extraction efficiency of information extraction of the information extraction model.

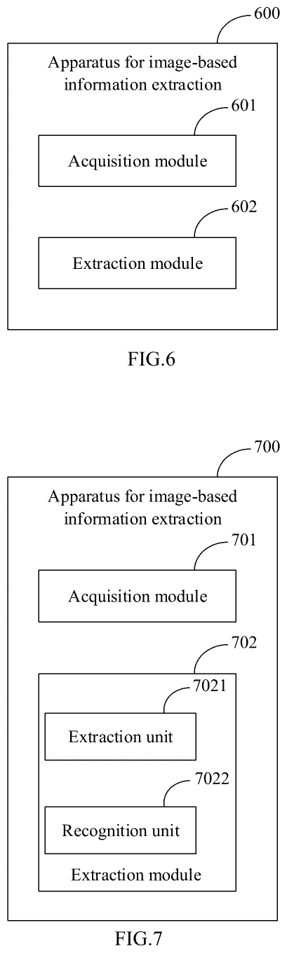

FIG. 6 is a schematic diagram according to a fifth embodiment of the present disclosure. As shown in FIG. 5, this embodiment provides an apparatus 600 for image-based information extraction, including an acquisition module 601 configured to acquire a to-be-extracted first image and a category of to-be-extracted information; and an extraction module 602 configured to input the first image and the category into a pre-trained information extraction model to perform information extraction on the first image to obtain text information corresponding to the category.

An implementation principle and a technical effect of the apparatus 600 for image-based information extraction in this embodiment realizing information extraction by using the above modules are the same as those in the above related method embodiment. Details may be obtained with reference to the description in the above related method embodiment, and are not described herein.

FIG. 7 is a schematic diagram according to a sixth embodiment of the present disclosure. As shown in FIG. 7, this embodiment provides an apparatus 700 for image-based information extraction, including the modules with same names and same functions as shown in FIG. 6, i.e., an acquisition module 701 and an extraction module 702.

As shown in FIG. 7, in this embodiment, the extraction module 702 includes an extraction unit 7021 configured to input the first image and the category into the information extraction model to perform information extraction on the first image to obtain region information corresponding to the category; and a recognition unit 7022 configured to recognize the text information from the first image based on the region information.

Further optionally, in an embodiment of the present disclosure, the recognition unit 7022 is configured to clip, from the first image, a second image corresponding to information corresponding to the category in the first image based on the region information; and acquire the text information based on the second image.

Further optionally, in an embodiment of the present disclosure, the recognition unit 7022 is configured to perform text recognition on the second image by OCR to obtain the text information.

Further optionally, in an embodiment of the present disclosure, the extraction module 702, specifically, the extraction unit 7021 in the extraction module 702, is configured to input the first image into an image feature extraction module in the information extraction model to perform image feature extraction on the first image to obtain an image feature; input the category into a text feature extraction module in the information extraction model to perform text feature extraction to obtain a text feature; input the image feature and the text feature into a feature fusion module in the information extraction model and perform feature fusion based on a cross attention mechanism to obtain a fusion feature; and decode the fusion feature by using a decoder in the information extraction model, to obtain the region information.

Further optionally, in an embodiment of the present disclosure, the extraction module 702, specifically, the extraction unit 7021 in the extraction module 702, is configured to extract the image feature by down-sampling at least two layers layer by layer in the image feature extraction module; wherein resolution of the image feature is less than that of the first image.

Further optionally, in an embodiment of the present disclosure, the extraction module 702, specifically, the extraction unit 7021 in the extraction module 702, is configured to up-sample the image feature in the fusion feature by using the decoder, to obtain an up-sampling feature; perform a point multiplication operation on the up-sampling feature and the text feature in the fusion feature to obtain a point multiplication feature; and acquire the region information based on the point multiplication feature.

An implementation principle and a technical effect of the apparatus 700 for image-based information extraction in this embodiment realizing information extraction by using the above modules are the same as those in the above related method embodiment. Details may be obtained with reference to the description in the above related method embodiment, and are not described herein.

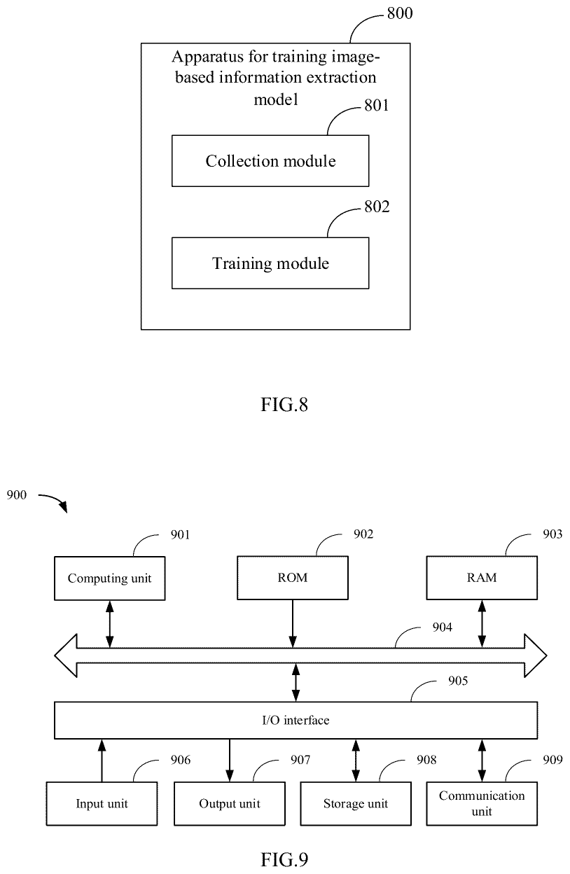

FIG. 8 is a schematic diagram according to a seventh embodiment of the present disclosure. As shown in FIG. 8, this embodiment provides an apparatus 800 for training image-based information extraction model, including an acquisition module 801 configured to acquire a training image sample, the training image sample including a training image, a training category of to-be-extracted information, and label region information of information corresponding to the training category in the training image; and a training module 802 configured to train an information extraction model based on the training image sample.

An implementation principle and a technical effect of the apparatus 800 for training image-based information extraction model in this embodiment realizing information extraction model training by using the above modules are the same as those in the above related method embodiment. Details may be obtained with reference to the description in the above related method embodiment, and are not described herein.

Further optionally, in an embodiment of the present disclosure, the training module 802 is configured to input the training image and the training category into the information extraction model to perform information extraction on the training image to obtain predicted region information corresponding to the training category; construct a loss function based on the predicted region information and the label region information; and adjust parameters of the information extraction model if the loss function does not converge.

Further optionally, in an embodiment of the present disclosure, the training module 802 is configured to input the training image into an image feature extraction module in the information extraction model to perform image feature extraction on the training image to obtain a training image feature; input the training category into a text feature extraction module in the information extraction model to perform text feature extraction to obtain a training text feature; input the training image feature and the training text feature into a feature fusion module in the information extraction model and perform feature fusion based on a cross attention mechanism to obtain a training fusion feature; and decode the training fusion feature by using a decoder in the information extraction model, to obtain the predicted region information.

Acquisition, storage, and application of users' personal information involved in the technical solutions of the present disclosure comply with relevant laws and regulations, and do not violate public order and moral.

According to embodiments of the present disclosure, the present disclosure further provides an electronic device, a readable storage medium, and a computer program product.

FIG. 9 is a schematic block diagram of an example electronic device 900 that may be configured to implement an embodiment of the present disclosure. The electronic device is intended to represent various forms of digital computers, such as laptops, desktops, workbenches, PDAs, servers, blade servers, mainframe computers and other suitable computers. The electronic device may further represent various forms of mobile devices, such as PDAs, cellular phones, smart phones, wearable devices and other similar computing devices. The components, their connections and relationships, and their functions shown herein are examples only, and are not intended to limit the implementation of the present disclosure as described and/or required herein.

As shown in FIG. 9, the device 900 includes a computing unit 901, which may perform various suitable actions and processing according to a computer program stored in a read-only memory (ROM) 902 or a computer program loaded from a storage unit 908 into a random access memory (RAM) 903. The RAM 903 may also store various programs and data required to operate the device 900. The computing unit 901, the ROM 902, and the RAM 903 are connected to one another by a bus 904. An input/output (I/O) interface 905 is also connected to the bus 904.

A plurality of components in the device 900 are connected to the I/O interface 905, including an input unit 906, such as a keyboard and a mouse; an output unit 907, such as various displays and speakers; a storage unit 908, such as disks and discs; and a communication unit 909, such as a network card, a modem and a wireless communication transceiver. The communication unit 909 allows the device 900 to exchange information/data with other devices over computer networks such as the Internet and/or various telecommunications networks.

The computing unit 901 may be a variety of general-purpose and/or special-purpose processing components with processing and computing capabilities. Some examples of the computing unit 901 include, but are not limited to, a central processing unit (CPU), a graphics processing unit (GPU), various AI computing chips, various computing units that run machine learning model algorithms, a digital signal processor (DSP), and any appropriate processor, controller or microcontroller, etc. The computing unit 901 performs the methods and processing described above, such as the method in the present disclosure. For example, in some embodiments, the method in the present disclosure may be implemented as a computer software program that is tangibly embodied in a machine-readable medium, such as the storage unit 908. In some embodiments, part or all of a computer program may be loaded and/or installed on the device 900 via the ROM 902 and/or the communication unit 909. One or more steps of the method in the present disclosure described above may be performed when the computer program is loaded into the RAM 903 and executed by the computing unit 901. Alternatively, in other embodiments, the computing unit 901 may be configured to perform the method in the present disclosure by any other appropriate means (for example, by means of firmware).

Various implementations of the systems and technologies disclosed herein can be realized in a digital electronic circuit system, an integrated circuit system, a field programmable gate array (FPGA), an application-specific integrated circuit (ASIC), an application-specific standard product (ASSP), a system on chip (SOC), a complex programmable logic device (CPLD), computer hardware, firmware, software, and/or combinations thereof. Such implementations may include implementation in one or more computer programs that are executable and/or interpretable on a programmable system including at least one programmable processor, which can be special or general purpose, configured to receive data and instructions from a storage system, at least one input apparatus, and at least one output apparatus, and to transmit data and instructions to the storage system, the at least one input apparatus, and the at least one output apparatus.

Program codes configured to implement the methods in the present disclosure may be written in any combination of one or more programming languages. Such program codes may be supplied to a processor or controller of a general-purpose computer, a special-purpose computer, or another programmable data processing apparatus to enable the function/operation specified in the flowchart and/or block diagram to be implemented when the program codes are executed by the processor or controller. The program codes may be executed entirely on a machine, partially on a machine, partially on a machine and partially on a remote machine as a stand-alone package, or entirely on a remote machine or a server.

In the context of the present disclosure, the machine-readable medium may be tangible media which may include or store programs for use by or in conjunction with an instruction execution system, apparatus or device. The machine-readable medium may be a machine-readable signal medium or machine-readable storage medium. The machine-readable medium may include, but is not limited to, an electronic, magnetic, optical, electromagnetic, infrared, or semiconductor system, apparatus or device, or any suitable combinations thereof. More specific examples of a machine-readable storage medium may include electrical connections based on one or more wires, a portable computer disk, a hard disk, an RAM, an ROM, an erasable programmable read only memory (EPROM or flash memory), an optical fiber, a compact disk read only memory (CD-ROM), an optical storage device, a magnetic storage device, or any suitable combination thereof.

To provide interaction with a user, the systems and technologies described here can be implemented on a computer. The computer has: a display apparatus (e.g., a cathode-ray tube (CRT) or a liquid crystal display (LCD) monitor) for displaying information to the user; and a keyboard and a pointing apparatus (e.g., a mouse or trackball) through which the user may provide input for the computer. Other kinds of apparatuses may also be configured to provide interaction with the user. For example, a feedback provided for the user may be any form of sensory feedback (e.g., visual, auditory, or tactile feedback); and input from the user may be received in any form (including sound input, speech input, or tactile input).

The systems and technologies described herein can be implemented in a computing system including background components (e.g., as a data server), or a computing system including middleware components (e.g., an application server), or a computing system including front-end components (e.g., a user computer with a graphical user interface or web browser through which the user can interact with the implementation mode of the systems and technologies described here), or a computing system including any combination of such background components, middleware components or front-end components. The components of the system can be connected to each other through any form or medium of digital data communication (e.g., a communication network). Examples of the communication network include: a local area network (LAN), a wide area network (WAN), and the Internet.

The computer system may include a client and a server. The client and the server are generally far away from each other and generally interact via the communication network. A relationship between the client and the server is generated through computer programs that run on a corresponding computer and have a client-server relationship with each other. The server may be a cloud server, a distributed system server, or a server combined with blockchain.

It should be understood that the steps can be reordered, added, or deleted using the various forms of processes shown above. For example, the steps described in the present disclosure may be executed in parallel or sequentially or in different sequences, provided that desired results of the technical solutions disclosed in the present disclosure are achieved, which is not limited herein.

The above specific implementations do not limit the scope of protection of the present disclosure. Those skilled in the art should understand that various modifications, combinations, sub-combinations, and replacements can be made according to design requirements and other factors. Any modifications, equivalent substitutions and improvements made within the spirit and principle of the present disclosure all should be included in the scope of protection of the present disclosure.

What is claimed is:

1. A method for image-based information extraction, comprising:
acquiring a to-be-extracted first image and a category of to-be-extracted information; and
inputting the first image and the category into a pre-trained information extraction model to perform information extraction on the first image to obtain text information corresponding to the category.

2. The method according to claim 1, wherein the inputting the first image and the category into a pre-trained information extraction model to perform information extraction on the first image to obtain text information corresponding to the category comprises:
inputting the first image and the category into the information extraction model to perform information extraction on the first image to obtain region information corresponding to the category; and
recognizing the text information from the first image based on the region information.

3. The method according to claim 2, wherein the recognizing the text information from the first image based on the region information comprises:
clipping, from the first image, a second image corresponding to information corresponding to the category in the first image based on the region information; and
acquiring the text information based on the second image.

4. The method according to claim 3, wherein the acquiring the text information based on the second image comprises:
performing text recognition on the second image by optical character recognition (OCR) to obtain the text information.

5. The method according to claim 2, wherein the inputting the first image and the category into the information extraction model to perform information extraction on the first image to obtain region information corresponding to the category comprises:
inputting the first image into an image feature extraction module in the information extraction model to perform image feature extraction on the first image to obtain an image feature;
inputting the category into a text feature extraction module in the information extraction model to perform text feature extraction to obtain a text feature;
inputting the image feature and the text feature into a feature fusion module in the information extraction model and performing feature fusion based on a cross attention mechanism to obtain a fusion feature; and
decoding the fusion feature by using a decoder in the information extraction model, to obtain the region information.

6. The method according to claim 5, wherein the inputting the first image into an image feature extraction module in the information extraction model to perform image feature extraction on the first image to obtain an image feature comprises:
extracting the image feature by down-sampling at least two layers layer by layer in the image feature extraction module;
wherein resolution of the image feature is less than that of the first image.

7. The method according to claim 5, wherein the decoding the fusion feature by using a decoder in the information extraction model, to obtain the region information comprises:
up-sampling the image feature in the fusion feature by using the decoder, to obtain an up-sampling feature;
performing a point multiplication operation on the up-sampling feature and the text feature in the fusion feature to obtain a point multiplication feature; and
acquiring the region information based on the point multiplication feature.

8. The method according to claim 3, wherein the inputting the first image and the category into the information extraction model to perform information extraction on the first image to obtain region information corresponding to the category comprises:
inputting the first image into an image feature extraction module in the information extraction model to perform image feature extraction on the first image to obtain an image feature;
inputting the category into a text feature extraction module in the information extraction model to perform text feature extraction to obtain a text feature;
inputting the image feature and the text feature into a feature fusion module in the information extraction model and performing feature fusion based on a cross attention mechanism to obtain a fusion feature; and
decoding the fusion feature by using a decoder in the information extraction model, to obtain the region information.

9. The method according to claim 4, wherein the inputting the first image and the category into the information extraction model to perform information extraction on the first image to obtain region information corresponding to the category comprises:
inputting the first image into an image feature extraction module in the information extraction model to perform image feature extraction on the first image to obtain an image feature;
inputting the category into a text feature extraction module in the information extraction model to perform text feature extraction to obtain a text feature;
inputting the image feature and the text feature into a feature fusion module in the information extraction model and performing feature fusion based on a cross attention mechanism to obtain a fusion feature; and
decoding the fusion feature by using a decoder in the information extraction model, to obtain the region information.

10. A method for training image-based information extraction model, comprising:
acquiring a training image sample, the training image sample comprising a training image, a training category of to-be-extracted information, and label region information of information corresponding to the training category in the training image; and
training an information extraction model based on the training image sample.

11. The method according to claim 10, wherein the training an information extraction model based on the training image sample comprises:
inputting the training image and the training category into the information extraction model to perform information extraction on the training image to obtain predicted region information corresponding to the training category;
constructing a loss function based on the predicted region information and the label region information; and
adjusting parameters of the information extraction model if the loss function does not converge.

12. The method according to claim 11, wherein the inputting the training image and the training category into the information extraction model to perform information extraction on the training image to obtain predicted region information corresponding to the training category comprises:
inputting the training image into an image feature extraction module in the information extraction model to perform image feature extraction on the training image to obtain a training image feature;
inputting the training category into a text feature extraction module in the information extraction model to perform text feature extraction to obtain a training text feature;
inputting the training image feature and the training text feature into a feature fusion module in the information extraction model and performing feature fusion based on a cross attention mechanism to obtain a training fusion feature; and
decoding the training fusion feature by using a decoder in the information extraction model, to obtain the predicted region information.

13. An electronic device, comprising:
at least one processor; and
a memory communicatively connected with the at least one processor;
wherein the memory stores instructions executable by the at least one processor, and the instructions are executed by the at least one processor to enable the at least one processor to perform a method for image-based information extraction, wherein the method comprises:
acquiring a to-be-extracted first image and a category of to-be-extracted information; and
inputting the first image and the category into a pre-trained information extraction model to perform information extraction on the first image to obtain text information corresponding to the category.

14. The electronic device according to claim 13, wherein the inputting the first image and the category into a pre-trained information extraction model to perform information extraction on the first image to obtain text information corresponding to the category comprises:
inputting the first image and the category into the information extraction model to perform information extraction on the first image to obtain region information corresponding to the category; and
recognizing the text information from the first image based on the region information.

15. The electronic device according to claim 14, wherein the recognizing the text information from the first image based on the region information comprises:
clipping, from the first image, a second image corresponding to information corresponding to the category in the first image based on the region information; and
acquiring the text information based on the second image.

16. The electronic device according to claim 15, wherein the acquiring the text information based on the second image comprises:
performing text recognition on the second image by OCR to obtain the text information.

17. The electronic device according to claim 14, wherein the inputting the first image and the category into the information extraction model to perform information extraction on the first image to obtain region information corresponding to the category comprises:
inputting the first image into an image feature extraction module in the information extraction model to perform image feature extraction on the first image to obtain an image feature;
inputting the category into a text feature extraction module in the information extraction model to perform text feature extraction to obtain a text feature;
inputting the image feature and the text feature into a feature fusion module in the information extraction model and performing feature fusion based on a cross attention mechanism to obtain a fusion feature; and
decoding the fusion feature by using a decoder in the information extraction model, to obtain the region information.

18. The electronic device according to claim 17, wherein the inputting the first image into an image feature extraction module in the information extraction model to perform image feature extraction on the first image to obtain an image feature comprises:
extracting the image feature by downsampling at least two layers layer by layer in the image feature extraction module;
wherein resolution of the image feature is less than that of the first image.

19. The electronic device according to claim 17, wherein the decoding the fusion feature by using a decoder in the information extraction model, to obtain the region information comprises:
up-sampling the image feature in the fusion feature by using the decoder, to obtain an up-sampling feature;
performing a point multiplication operation on the up-sampling feature and the text feature in the fusion feature to obtain a point multiplication feature; and
acquiring the region information based on the point multiplication feature.

20. A non-transitory computer readable storage medium with computer instructions stored thereon, wherein the computer instructions are used for causing a method for image-based information extraction, wherein the method comprises:
acquiring a to-be-extracted first image and a category of to-be-extracted information; and
inputting the first image and the category into a pre-trained information extraction model to perform information extraction on the first image to obtain text information corresponding to the category.
